(19) United States
(12) Patent Application Publication
(10) Pub. No.: US 2010/0271278 A1
(43) Pub. Date: Oct. 28, 2010

(54) BISTATIC ARRAY ANTENNA AND METHOD

(76) Inventors: Thomas Binzer, Stuttgart (DE); Dirk Steinbuch, Wimsheim (DE)

Correspondence Address: KENYON & KENYON LLP, ONE BROADWAY, NEW YORK, NY, 10004, US

(21) Appl. No.: 12/745,944

(22) PCT Filed: Oct. 13, 2008
(86) PCT No.: PCT/EP08/63735

§ 371 Date: Jun. 3, 2010

(30) Foreign Application Priority Data
Dec. 4, 2007 (DE) 10 2007 058 236.8

(51) Int. Cl. H01Q 15/02; H01Q 21/08

(52) U.S. Cl. 343/824; 343/909

(57) ABSTRACT

In a bistatic array antenna, beam focusing in preferred directions of the array antenna occurs with the aid of a focusing arrangement in such a way that beam focusing occurs both in a first preferred direction for the array elements of the transmit mode as well as in another second preferred direction for the array elements of the receive mode.

### FIELD OF THE INVENTION

The present invention relates to a bistatic array antenna having a focusing arrangement for beam focusing, and a method for operating such an antenna.

### BACKGROUND INFORMATION

A radar sensor having digital beam shaping requires large antenna arrays, particularly if narrow beams are required such as in long range radar. This conflicts with the desire to manufacture a sensor that is as small in surface area as possible, however. Alternatively, a (cylindrical) lens may be used, which results in a narrowing of the beams in one plane (elevation) and reduces the number of antenna elements in elevation, for example as described in PCT Application No. WO 2006/048352 A2. This does not change the geometric dimensions in the azimuth direction however.

Another alternative is a monostatic radar system, in which the same antenna is used for transmitting and receiving, for example as described in PCT Application No. WO 2006/029926A1. However, this means that transmitting and receiving characteristics cannot be selected independently of each other.

### SUMMARY

Using a bistatic array antenna in accordance with the present invention, in which a focusing arrangement for beam focusing in preferred directions of the array antenna is developed and situated in such a way that beam focusing occurs both in a first preferred direction for the array elements of the transmit mode as well as in another preferred direction for the array elements of the receive mode, it is possible to achieve beam focusing at a very low surface area requirement, in particular in elevation, using separate array elements for the transmit mode and the receive mode.

Furthermore, in a development according to an example embodiment of the present invention, it is possible to achieve digital beam shaping having narrow radiation lobes and angle estimations, particularly in the azimuth direction, likewise with a very low surface area requirement.

When using a focusing arrangement in the form of a bifocal lens, in particular a bifocal cylindrical lens, beam focusing is achieved in a plane, in which no digital beam shaping occurs, preferably in elevation. The beam focusing in preferred directions for elevation may thus be adjusted in an optimized manner and independently of the azimuth separated according to the array elements for the transmit mode and the receive mode.

The array elements are preferably situated across from the focusing arrangement/the bifocal cylindrical lens in such a way that the phase source point of the array elements for the receive mode and for the transmit mode is located respectively in one focal point of the focusing arrangement/the bifocal lens. As a consequence, the array elements for the receive mode and for the transmit mode may be arranged separated in elevation one above the other instead of side by side as in conventional design approaches. This results in a substantially lower surface area requirement. The beam focusing occurs preferably in elevation by array elements on a substrate and the focusing arrangement/bifocal lens and in azimuth only by the array elements on the substrate. The entire base width of the antenna array is available for beam focusing/digital beam shaping in the azimuth and thus allows for wide beam swinging in the azimuth in transmit mode and for a reliable evaluation in receive mode.

Patch elements, slot elements or patch elements having a polyrod on a substrate may be used alternatively as array elements. In elevation, multiple array elements or rows of array elements may be used to ensure an optimized side lobe attenuation.

### BRIEF DESCRIPTION OF THE DRAWINGS

Specific embodiments of the present invention are explained in greater detail below with reference to the figures.

FIG. 1 shows a top view of an antenna array having separate regions of array elements for transmit and receive mode.

FIG. 2 shows a section through a bifocal lens.

FIG. 3 shows a lateral view of the antenna array together with a bifocal lens situated in front of it.

### DETAILED DESCRIPTION OF EXAMPLE EMBODIMENTS

The present invention provides a focusing arrangement/device for beam focusing in two preferred directions of a radar array antenna for bistatic operation, i.e., different array elements are provided for a transmit mode than for a receive mode. The focusing arrangement effects beam focusing in a first preferred direction of the elevation for the transmit mode and beam focusing in another second preferred direction of the elevation for the receive mode. Below, a bifocal lens is described as a focusing arrangement/device, in particular, a bifocal cylindrical lens having two different focal points. Instead of such a bifocal cylindrical lens, suitable grid structures of other dielectric structures may be used as well, which likewise have two focal points or focal lines.

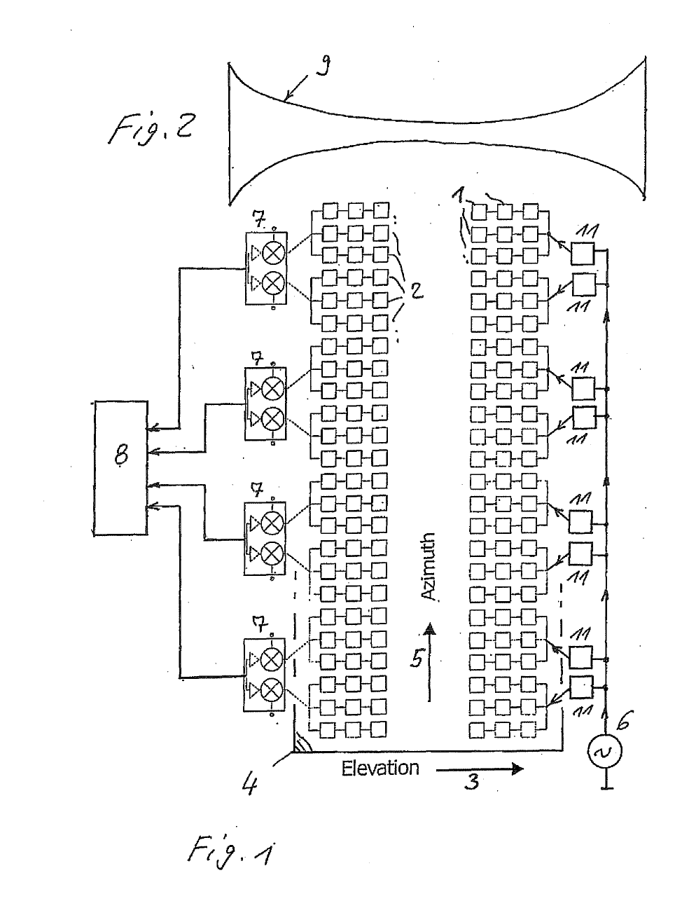

FIG. 1 shows the arrangement of array elements 1 for the transmit mode and array elements 2 for the receive mode. Relative to elevation direction 3, array elements 1 for the transmit mode and 2 for the receive mode are situated one above the other in accordance with an example embodiment of the present invention. In the exemplary embodiment shown in FIG. 1, respectively three array rows are arranged in elevation 3 and respectively 24 array columns in azimuth 5. Patch elements, slot elements or patch elements having a polyrod are provided as array elements 1 and 2 on or in a substrate 4. Array elements 1 for the transmit mode are controlled from a high-frequency oscillator 6. The individual array elements 1 are interconnected into groups of respectively 3×3 elements in elevation and azimuth. In azimuth 5, i.e., in another preferred direction, which is common to both array elements 1 for the transmit mode as well as to array elements 2 for the receive mode, the control operation is performed via phase shifters 11 in order to be able to set a desired directional characteristic of the radiation lobes and also to switch it over if necessary. For the receive mode, the array elements are also interconnected into groups of respectively 3×3 elements. This configuration may also be selected differently of course. Two of these groups of array elements 2 are respectively connected to a mixing device 7, which respectively has two mixers on one chip. When using a homodyne mixture, as described in PCT Application No. WO 2006/029926 A1, for instance, a portion of the signal of oscillator 6 generating the signal to be transmitted is diverted and used as local oscillator signal such that the transmitted signal and the signal of the local oscillator have the same frequency. The intermediate frequency then corresponds to the frequency difference between the local oscillator signal and the received signal and, in a Doppler radar, is a function of the Doppler shift. In an FMCW radar, the frequency of the transmitted signal and consequently also the local oscillator frequency is modulated in a ramp-like manner. The intermediate frequency is then also a function of the signal propagation time and thus of the distance of the located object, and lies in an order of magnitude of 0 to a few 100 KHz.

In an evaluation device 8, the different mixed received signals (intermediate frequency signals) of mixing devices 7 are sampled in a time-synchronous manner (digitized) and subjected to a conventional digital beam shaping (DBF, digital beam forming). Because of the fixed phase and amplitude relation of the individual received signals in azimuth, it is possible to extract both the distance and also the angle information of radar targets.

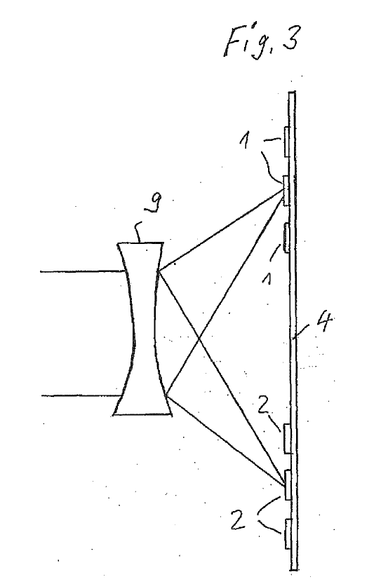

In front of the plane of substrate 4, on which array elements 1 and 2 are situated, a bifocal cylindrical lens 9 is disposed, which is shown in cross section in FIG. 2. The lateral view in FIG. 3 shows that array elements 1 for the transmit mode and array elements 2 for the receive mode are respectively situated in a focal point of bifocal cylindrical lens 9 or the phase source points of the transmit and receive array surfaces are respectively situated in a focal point of bifocal lens 9. The beam focusing of the bistatic array antenna accordingly occurs in elevation by array elements 1 and 2 on substrate 4 and bifocal lens 9 and in the azimuth only by the array elements on substrate 4 by way of digital beam shaping.

If, as shown in FIG. 1, multiple lines of array elements are provided in elevation, then it is possible to ensure an optimized side lobe attenuation.

1-10. (canceled)

11. A bistatic array antenna, comprising:
array elements for a transmit mode and array elements for a receive mode; and
a focusing arrangement for beam focusing in preferred directions of the array antenna, the focusing arrangement being situated in such a way that beam focusing occurs both in a first preferred direction for the array elements of the transmit mode and in a second preferred direction for the array elements of the receive mode.

12. The bistatic array antenna as recited in claim 11, further comprising:
a digital beam shaping arrangement to beam shape in an additional preferred direction that is common to the array elements for the transmit mode and to the array elements for the receive mode.

13. The array antenna as recited in claim 11, wherein the focusing arrangement is a bifocal lens.

14. The array antenna as recited in claim 11, wherein the bifocal lens is a bifocal cylindrical lens.

15. The array antenna as recited in claim 11, wherein the first and the second preferred directions are elevation directions with respect to a plane of the antenna array.

16. The array antenna as recited in claim 12, wherein the additional preferred direction is an azimuth direction with respect to the plane of the antenna array.

17. The array antenna as recited in claim 13, wherein a phase source point of the array elements for the receive mode and a phase source point of the array elements for the transmit mode is respectively located in a focal point of the bifocal lens.

18. The array antenna as recited in claim 11, wherein the array elements for the receive mode and the array elements for the transmit mode are arranged in elevation separated one above the other.

19. The array antenna as recited in claim 11, wherein patch elements are situated as array elements on a substrate.

20. The array antenna as recited in claim 11, wherein slots are situated as array elements in a substrate.

21. A method for operating a bistatic array antenna having a focusing arrangement for beam focusing, the focusing arrangement being developed and attached in front of array elements of the antenna, the method comprising:
beam focusing respectively in a first preferred direction for array elements in transmit mode, and
beam focusing in a second preferred direction for array elements in receive mode.
